(19) United States
(12) Patent Application Publication
(10) Pub. No.: US 2011/0181011 A1
(43) Pub. Date: Jul. 28, 2011

(54) METHOD AND APPARATUS FOR ADJUSTING AXLE CAMBER

(75) Inventor: Zachary Alexander Merrill, Greenville, SC (US)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 12/952,583

(22) Filed: Nov. 23, 2010

Related U.S. Application Data
(63) Continuation-in-part of application No. 12/670,991, filed on Jan. 27, 2010.

(51) Int. Cl. B62D 17/00; B23P 11/00

(52) U.S. Cl. 280/86.751; 29/428

(57) ABSTRACT

A method for adjusting the camber of a vehicle's axle comprising attaching collars to the axle of the vehicle attaching links to the collars, introducing a deflection in the axle in a concave downward direction and modifying the length of the links.

### PRIORITY CLAIM

This application claims the benefit of previously filed U.S. Non-provisional patent application entitled, “Method for Adjusting Axle Camber”, assigned U.S. Ser. No. 12/670,991, filed Jan. 27, 2010, and which is incorporated herein by reference in its entirety for all purposes.

### BACKGROUND OF THE INVENTION

1. Field of the Invention

The present invention relates generally to vehicle axles and more specifically to trailer axles.

2. Description of the Related Art

A vehicle's axle supports the weight of the vehicle and load and also provides a shall upon which the wheels revolve. Truck rigs carrying heavy loads over long distances provide substantial forces to the axles. The allowable axle loads are restricted by law, typically tandem truck trailer axles are expected to carry loads of up to 34,000 pounds per tandem. In fact, the camber of the wheels on these loaded axles can be altered by these forces such that the wheels are closer together at the top then at the bottom. This condition is known as negative camber.

Most trailer axles are manufactured with no intentional camber but with an acceptance the when in use, there will be some degree of camber deflection attributable to load. On a new trailer axle, manufacturers typically accept a camber deflection attributable tolerance of about one quarter of a degree, positive or negative. This tolerance applies to the axle beam itself with no load applied and with no consideration for additional camber deflection that may be experienced by components of the hub and the wheel. On a typical truck semi-trailer, even with the minimal load applied by the weight of the empty trailer, each axle end may have a load of approximately 2000 pounds. This load is sufficient to cause the wheels to exhibit a negative camber orientation.

A fully loaded trailer may support a load of about 8500 pounds to each axle end and typically causes as much as one half degree or more of negative camber at the tire. This negative camber indicates that the contact surface of the tires is not parallel to the road surface. Consequently, the tread may wear unevenly, with the inner shoulder wearing most rapidly. When the truck is driven with a reduced load, the inner shoulder may not make firm contact with the ground, which allows slipping.

One solution to the problem above is to remove the axle and deflect it mechanically, or by other means, in the opposite direction. An example of one known technique for effecting a camber change to an axle is by applying heat to the axle to accomplish a plastic deformation. However, manufacturers frequently disapprove of such practices because the variables of the necessary plastic deformation are difficult to control and often explicitly void the warranty. Furthermore, this practice is time consuming and it is difficult to achieve the precise camber required without iterative trials.

### SUMMARY OF THE INVENTION

A method is provided for adjusting the camber of a truck's trailer axle comprising attaching a first collar to the axle of the vehicle proximate to a first wheel of the vehicle, said first collar having first and second offset link attachments and attaching a second collar to the axle of the vehicle, opposite from the first wheel proximate to a second wheel of the vehicle, said second collar having first and second offset link attachments. Also, a first link is provided that is operatively associated with the first offset link attachment of the first collar and the first offset link attachment of the second collar as well a second link that is operatively associated with the second offset link attachments of the first and second collars. This camber truss assembly can then be used to introduce a deflection in a concave downward direction. Then, the length of the links can be adjusted or modified. This preload on the axle helps to compensate for the axle's negative camber created by the weight of the vehicle, improving the wear performance of tires on the axle.

The operative association of the first link to the first offset link attachments of the first and second collars may involve direct connections between the first link and these attachments but it may involve other members interposed between the first link these offset link attachments such as when a triangular pattern is formed between the axle and multiple links for increased force and moment generation. In other words, the first link may be used as a conduit to transfer force or moment to the offset link attachments using additional components. This same principle applies to the operative association of the second link to the second offset link attachments of the first and second collars.

A particular embodiment of the apparatus that can be used for adjusting the camber of a truck's trailer axle comprises a first collar with first and second offset link attachments, a second collar with first and second offset link attachments, a third collar with an extension and a movable member that can exposed an opening for allowing a link to pass through it. A first link can be attached from the first offset link attachment of the first collar to the first offset link attachment of the second collar. This first link may extend through the opening of the extension of the third collar. A second link can also be provided that is attached to the second offset link attachments of the first and second collars. In some cases, the links used can comprise turnbuckles.

### BRIEF DESCRIPTION OF THE DRAWINGS

FIG. 1 is a rear view of a truck's trailer axle;

FIG. 2 is a simplified force diagram showing the forces applied to the trailer axle while under load;

FIG. 3 is a rear view of a truck's trailer axle showing a 3-collar camber truss assembly;

FIG. 4 is a simplified force diagram showing the forces applied to the trailer axle while the trailer is supported by an inner offset link attachment;

FIG. 5 is a rear view of a truck's trailer axle showing a 3-collar camber truss assembly with a pair of spacer collars;

FIG. 6 is a rear view of a truck's trailer axle showing a 5-collar camber truss assembly;

FIG. 7 is a perspective view of a removable jacking fixture; and

FIG. 8 is a rear view of a truck's trailer axle showing a camber truss assembly having links found above and below the axle.

### DETAILED DESCRIPTION OF PARTICULAR EMBODIMENTS

Advantageously, particular embodiments of the present invention provide a method that adjusts the camber of a truck's trailer axle. Other embodiments provide a method that modifies an introduced negative camber of the truck's trailer wheels when a load is applied. The technology has particular applicability to the trailer axles of a semi-truck rig. However, the invention could be applied to other vehicles as well as any axle bearing a load.

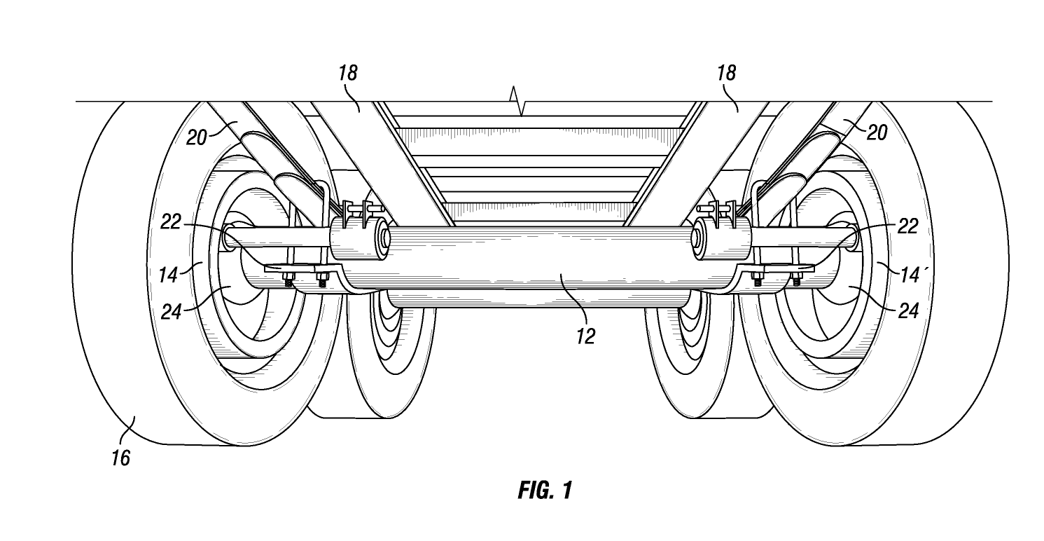

Referring now to the drawings, FIG. 1 illustrates a rear view of a truck's trailer axle 12. As illustrated in FIG. 1, the truck is supported for travel over ground by wheels with attached pneumatic tires. The left wheel 14 and right wheel 14′ are attached to an axle 12. The trailer has a pair of frame members 18 which support the weight of the trailer. The frame members 18 are separated from the axle 12 by a pair of springs 20. The springs 20 shown in FIG. 1 are metal leaf springs, although composite leaf springs and air springs are also commonly known in the art. Air springs are airtight units and are connected to a source of compressed air on board the truck. The springs 20 are attached to the axle 12 by means of a spring hanger 22. Also shown attached to the wheels 14 and 14′ is a brake backing plate 24.

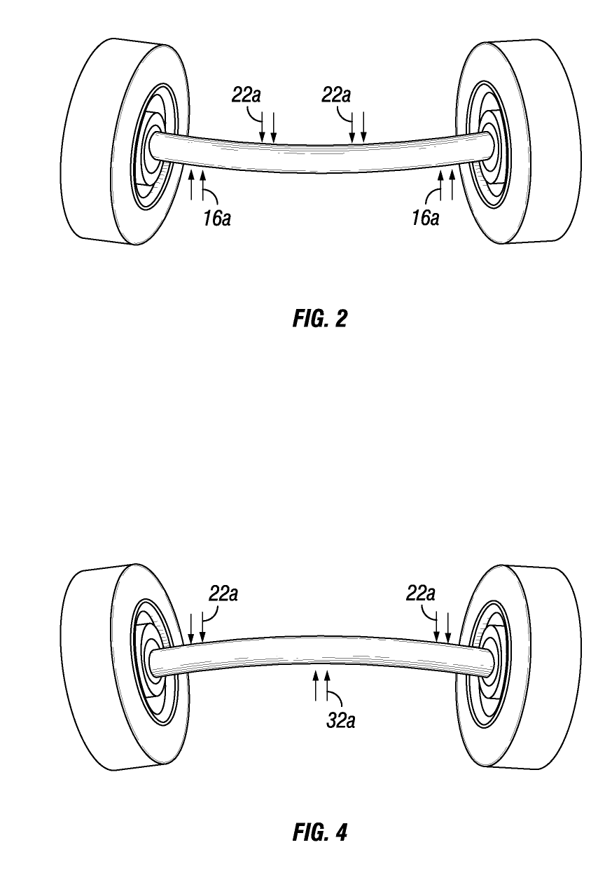

With the trailer axle configuration shown in FIG. 1, the ground supplies an upward force to the tire and wheel combinations, while the weight of the trailer is translated to the axle 12, inboard of the wheels 14 and 14′, via the air springs 20. FIG. 2 shows a simplified depiction of the forces applied to the axle 12. As shown in FIG. 2, the forces cause the axle 12 to be deflected in a concave downward direction.

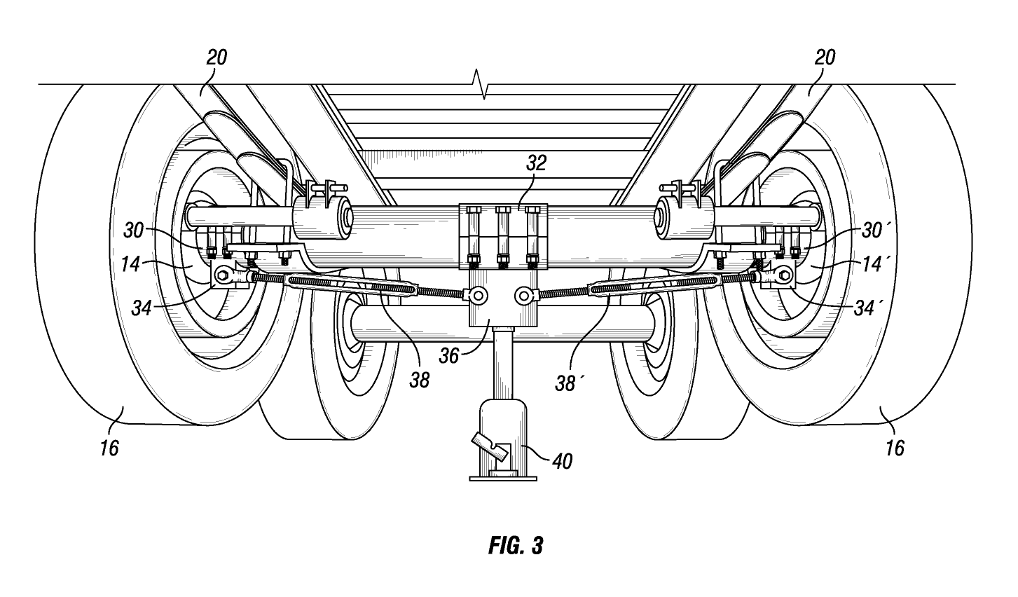

Referring to FIG. 3, a first collar 30 is attached to the axle 12 proximate to the left wheel, and a second collar 30′ is attached to the axle 12 proximate to the right wheel. The collars 30 and 30′ may be attached in the space between the spring hanger 22 and the brake backing plate 24. In a preferred embodiment, the collar should take up all the space between the spring hanger 22 and the brake backing plate 24 in order to increase the deflection resistance of the axle 12. Attached to the underside of the collars 30 and 30′ are offset link attachments 34 and 34′. Between the collars 30 and 30′ is a third, inner collar 32, also attached to the axle 12. Attached to the underside of the inner collar 32 is an inner offset link attachment 36. The inner collar 32 is attached to collar 30 by a link 38 and to collar 30′ by a link 38′. The links 38 and 38′ are connected to the offset link attachments 34, 34′ and 36 of their respective collars 30, 30′ and 32, for example, by means of a clevis pin. The clevis attachment point for the inner collar 32 should be as long in the vertical direction from the axle 12 as possible, taking into consideration ground clearance considerations. Conversely, the clevis attachment point for the collars 30 and 30′ should be as short a vertical distance as practical to the axle 12. The offset link attachments 34, 34′ and 36 may each have more than one attachment point in order to provide for adjustable geometry. In the figure, the links 38 and 38′ are shown as a turnbuckle, but any threaded adjustable device including a toe sleeve can be used. Alternatively, a hydraulic or pneumatic piston can be used instead of a mechanical device. The axle, links 38 and 38′, collars 30 and 30′, inner collar 32, offset link attachments 34 and 34′, and inner offset link attachment 36, constitute a camber truss assembly. Also shown below the inner offset link attachment 36 in FIG. 3 is a standard 20 ton shop jack 40.

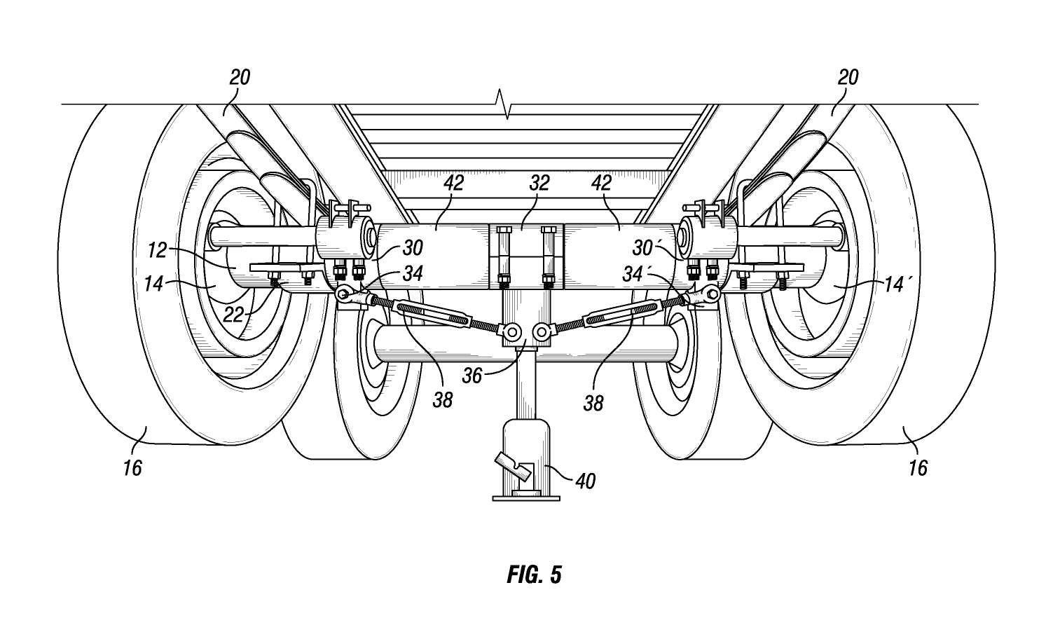

In certain embodiments where the trailer's air spring configuration does not permit placing the collars 30 and 30′ outboard of the spring hangers 22, the collars may be placed inboard of the spring hangers 22. FIG. 5 shows this configuration. To prevent the collars 30 and 30′ from slipping towards the inner collar 32 once tension is applied to the links 38 and 38′, a pair of spacer devices 42 may be placed between the collars 30 and 30′, and the inner collar 32. The spacer devices may take the form of a rod, beam, or a collar as is shown in FIG. 5.

In a particular embodiment of the invention, the loaded trailer is lifted off the ground by contacting a shop jack 40 with the inner offset link attachment 36. However, any means of lifting the trailer off the ground such as a standard lift may be used. FIG. 4 shows a simplified depiction of the forces applied to the axle 12 with the trailer supported by the inner offset link attachment 36, rather than the tire and wheel combination as shown in FIG. 2. The weight of the truck applied to the axle 12 via the spring hangers 22, while the axle 12 is supported proximate to its center, causes the axle 12 to deflect in a concave downward direction. In the instances where the trailer utilizes air springs, it is preferable to release the air from both the front and rear air springs prior to lifting the trailer. This is done to assist in lifting the tires and wheel combination off the ground so that all the weight of the truck is applied to the inner offset link attachment 36.

After lifting the loaded trailer off the ground, the length of the links 38 and 38′ are reduced, causing them to come into tension. Once the shop jack 40 is subsequently removed, the load of the trailer is once again supported by the tire and wheel combination. However, the camber truss assembly now supplies sufficient rigidity to the axle 12 to resist much of the bending moment. The camber truss assembly thus preserves most of the current axle camber correction. If too much deflection is introduced in the axle 12 by supporting the load of the trailer at the inner offset link attachment 36, the tension in the links 38 and 38′ may be reduced until a desired setting is reached. Although this setting might be zero camber, other settings are possible. If the links 38 and 38′ are later removed from the axle 12, the axle 12 returns to its original deflection, because there is no significant plastic deformation.

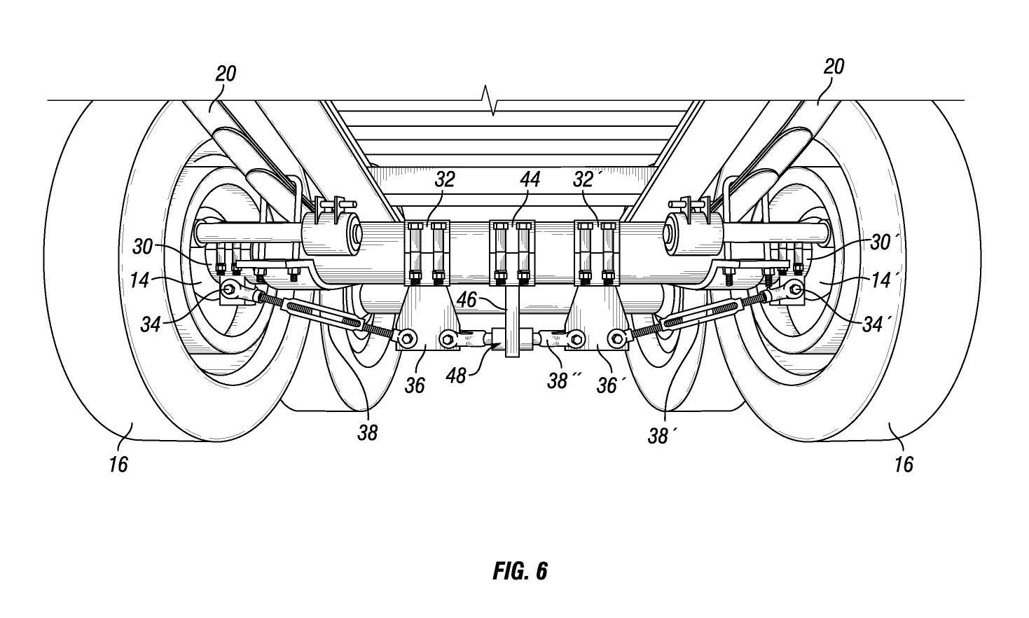

FIG. 6 shows an alternative embodiment of the invention. In certain cases where it is not possible to fit the 3-collar design onto the axle because of constraints imposed by the suspension and braking configurations, a 4-collar design may be utilized (so called since only four collars usually remain attached to the axle while a fifth collar is used temporarily to lift the axle as will be described in more detail below). In FIG. 6, a pair of collars 30 and 30′ are attached to the axle 12 proximate to the left and right wheels 14 and 14′ respectively. Attached to the underside of the collars 30 and 30′ are offset link attachments 34 and 34′. Between the collars 30 and 30′, an inner collar 32 is attached to the axle 12 proximate to collar 30 and an inner collar 32′ is attached to the axle 12 proximate to collar 30′. Attached to the underside of the inner collars 32 and 32′ are inner offset link attachments 36 and 36′. Between the inner collars 32 and 32′ a fifth collar 44 is attached to the axle. Attached to the underside of the fifth collar 44 is an extension 46. The extension 46 contains an opening 48 through which a link may extend.

The utilization of the 4-collar design is similar to the 3-collar design with the following exceptions. Collar 30 is attached to inner collar 32 with link 38. Collar 30′ is attached to inner collar 32′ with link 38′. The inner collars 32 and 32′ are then connected to each other by a link 38″ which passes through the opening 48 in the extension 46. The loaded trailer is lifted off the ground by contacting the shop jack 40 with the extension 46 of the fifth collar 44. Once the loaded trailer is off the ground, the lengths of each of the links are reduced, causing the links to come into tension. The fifth collar 44 may be removed after the desired camber correction has been made, but it should be removed without disturbing the links. To facilitate this, the extension 46 should have a removable rod 50 or, in an alternative embodiment, a hinge portion which retains the structural integrity of the extension 46 during loading.

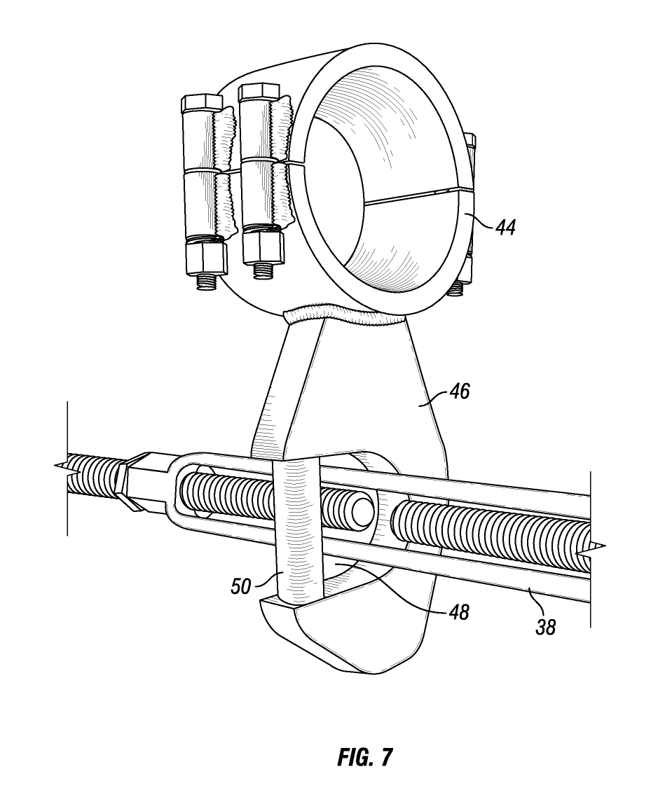

FIG. 7 shows a closer view of the fifth collar 44 and extension 46 with a removable rod 50. The removable rod 50 can be moved in and out of the extension opening by hand until sufficient force is applied to the extension 46; for example, by contacting the extension 46 with a floor jack. At that point, the extension 46 is temporarily deformed, clamping the rod 50 into place. Once the lengths of the links have been modified, the rod is removed, allowing the fifth collar to be taken off the axle as the link that passes through the opening no longer hinders the collar's removal.

Another application that frequently occurs in the field involves the use of a trailer suspension system sold by HENDRICKSON under the trademarks VANTRAAX or INTRAAX. This suspension system often employs the use of air springs and brackets and is commonly used with New Generation Wide Base Single tires such as those sold by MICHELIN under the trademark XONE. However, the configuration of the suspension system including the air springs and brackets prohibit the placement of any collars of the aforementioned embodiments of a camber truss assembly to be placed outboard of the brackets so they must be placed inboard thereof. Even so, the distance between the brackets and air springs on one side of the suspension to those found on the other side of the suspension is only about thirty-two inches. Experience has taught that an embodiment, such as that shown in FIG. 5, which is placed inside of these brackets has insufficient leverage to create enough of a bending moment to compensate for the deflection of the trailer under load and its associated camber angle. Consequently, the following embodiment has been developed.

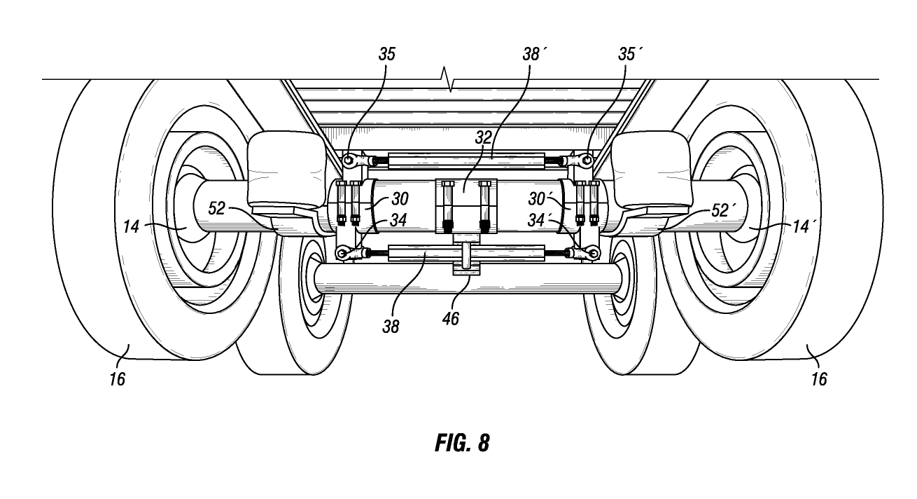

Looking at FIG. 8, this embodiment comprises a link 38 below the axle in addition to a link 38′ above the axle 12 that can create additional leverage for increasing the moment or torque supplied to the axle 12. The structure and use of this embodiment is as follows. A first collar 30 with first and second offset link attachments 34, 35 is attached to the axle 12 by means commonly known in the art, such as by a clamping action created by fasteners that cause the collar to collapse around the axle for example. The first collar 30 is positioned just inside a bracket 52 of the suspension system. Then, a second collar 30′ with first and second offset link attachments 34′, 35′ is attached to the axle 12 opposite the first collar 30 just inside the other bracket 52′ of the suspension system by the same means. The orientation of the collars is preferably but not necessarily such that the offset link attachments are aligned substantially in a vertical direction. Deviation from this orientation in some instances can alter the toe angle of the axle and may be an intentional outcome for compensating for undesirable toe angle of the axle.

Next, a first link 38 is attached to the first and second collars 30, 30′ using their first offset attachments 34, 34′ found below the axle 12 using a clevis pin or some other means commonly known in the art. After that, a second link 38′ is attached to the first and second collars 30, 30′ using their second offset attachments 35, 35′ found above the axle 12 using similar means. Then, a third collar 32 and extension 46 are attached to the axle 12, preferably at the center thereof, and the axle 12 is lifted and deflected, all as described for the embodiment shown by FIG. 7. Finally, the length of the first link 38 is shortened creating tension on the first link 38 and the length of the second link 38′ is increased creating compression on the second link 38′. This may involve rotating turnbuckles, which the links may comprise, in the appropriate directions. Thus, approximately double the moment can be exerted on the axle using both links as compared to a single link found below the axle.

In some cases, the third collar 32 and extension 46 are then removed. Of course, this embodiment may have features that are substituted for those contained in previous embodiments. For example, additional links below the axle that have a triangular arrangement such as is shown in FIG. 5 could be used. In some cases where there is enough clearance between the bottom of the trailer and the axle, additional links could be added above the axle that are also arranged in a triangular pattern to provide even more moment or torque. It is advantageous that such triangular arrangements of links be used above and below the axle to maximize the available moment that can be exerted on the axle but there may not be enough room for such a configuration in many applications. In addition, the third collar 32 such as that shown in FIGS. 3 and 5 may be used and can be left attached to the axle even after a deflection has been imposed and retained by modifying the lengths of the links. Also, the first and second collars could be placed outboard of the brackets, spring hangers, or other structural members that attach the axle to the vehicle, if room permits, providing even more leverage.

The collars described herein for this latest embodiment have first and second offset link attachments that are diametrically opposed to each other above and below the clamp attachment of the collar but it is envisioned that other configurations could be used. For example, a projection could be located on the collar diametrically opposite to the clamp attachment that extends above and below the diameter of the collar to provide upper and lower attachment points that are used as first and second offset link attachments. Virtually any configuration of a collar could be used as long as it provides two attachment points that are sufficiently far enough from each other to allow force, moment or torque to be applied to the collar on different sides of the axle. Therefore, the term first and second offset link attachments should be interpreted broadly.

Likewise, while this invention has been described with reference to particular embodiments thereof, it shall be understood that such description is by way of illustration and not by way of limitation. For example, specific applications regarding certain suspension systems and tires, such as VANTRAAX and XONE, have been described herein but the embodiments of the present invention can be applied to a multitude of suspension systems and tires as well as to different types of vehicles including cars and light trucks. Furthermore, the weight of the trailer has been described as being lifted using a collar but it is contemplated that the use of a collar for lifting the trailer could be omitted and a cradle coupled to a lifting mechanism or some other means could be used to lift a trailer or axle to introduce a deflection. Finally, different aspects and features of some of the embodiments discussed herein may be substituted for other features of other embodiments to yield further embodiments. Accordingly, the scope and content of the invention is to be defined only by the terms of the appended claims.

What is claimed is:

1. A method for adjusting the camber of a vehicle's axle comprising:
attaching a first collar to the axle of the vehicle proximate to a first wheel of the vehicle, said first collar having first and second offset link attachments;
attaching a second collar to the axle of the vehicle, opposite from the first wheel proximate to a second wheel of the vehicle, said second collar having first and second offset link attachments;
providing a first link that is operatively associated with the first offset link attachment of the first collar and the first offset link attachment of the second collar;
providing a second link that is operatively associated with the second offset link attachment of the first collar and the second offset link attachment of the second collar;
introducing a deflection in the axle in a concave downward direction; and
modifying the length of the first and second links.

2. The method of claim 1, further comprising the step of attaching a third collar between the first and second collars having a first offset link attachment to the axle so that the first offset link attachment is below the axle and the step of introducing deflection in the vehicle axle comprises applying an upward force on the first offset link attachment of the third collar.

3. The method of claim 2, wherein the step of applying an upward force to the first offset link attachment of the third collar comprises applying the upward force with a jack.

4. The method of claim 1, wherein the step of providing a first link having an operative association with the first offset link attachments of the first and second collars comprises attaching the first link directly to the first offset link attachments of the first collar and second collars.

5. The method of claim 4, wherein the step of attaching the first link to the first offset link attachments of the first and second collars comprises attaching the links at two or more alternative locations on each offset link attachment.

6. The method of claim 1, wherein the step of modifying the length of the first and second links comprises rotating turnbuckles.

7. The method of claim 1, wherein the step of modifying the length of the first and second links comprises rotating toe sleeves.

8. The method of claim 2, wherein the step of attaching the third collar to the axle between the first and second collars comprises attaching the third collar at the center of the axle.

9. The method of claim 1, wherein the vehicle comprises a truck with a trailer having an axle.

10. The method of claim 9, further comprising releasing air from air springs attached to the trailer.

11. The method of claim 1, wherein said steps of attaching a first and second collar to the axle comprises attaching the first collar outboard of a structural member that connects the axle to the vehicle and attaching the second collar outboard of another structural member that connects the axle to the vehicle.

12. The method of claim 1, wherein said steps of attaching a first and second collar to the axle comprises attaching the first collar inboard of a structural member that connects the axle to the vehicle and attaching the second collar inboard of another structural member that connects the axle to the vehicle.

13. The method of claim 1, wherein the step of providing a second link having an operative association with the second offset link attachments of the first and second collars comprises attaching the second link directly to the second offset link attachments of the first collar and second collars.

14. The method of claim 2, wherein said step of providing a first link that is operatively associated with the first offset link attachments of the first and second collars further comprises attaching the first link directly to the first offset link attachment of the first collar and the first offset link attachment of the third collar and providing a third link that is directly attached to the first offset link attachment of the third collar and the first offset link attachment of the second collar.

15. The method of claim 14, wherein the attachments of the third link and the first link to the third collar are found vertically below the attachment of the first link to the first collar and the attachment of the third link to the second collar, forming a triangular pattern with the axle.

16. The method of claim 2, wherein the third collar further comprises a second offset link attachment located above the axle and the step of providing a second link that is operatively associated with the second offset link attachments of the first and second collars comprises attaching the second link directly to the second offset link attachment of the first collar and the second offset link attachment of the third collar and providing a fourth link that is attached to the second offset link attachment of the third collar and the second offset link attachment of the second collar.

17. The method of claim 16, wherein the attachments of the fourth link and the second link to the third collar are found vertically above the attachment of the second link to the first collar and the attachment of the fourth link to the second collar, forming a triangular pattern with the axle.

18. The method of claim 1, wherein the offset link attachments of the first and second collars are aligned substantially vertically and the first and second links are substantially straight members with the first link located below the axle and the second link located above the axle.

19. An apparatus for adjusting the camber of a truck's trailer axle comprising:
a first collar with first and second offset link attachments;
a second collar with first and second offset link attachments;
a third collar with an extension, said extension containing a movable section and an opening;
a first link attached between the first offset link attachments of the first and second collars so that the first link is located below the axle;
a second link attached between the second offset link attachments of the first and second collars so that the second link is located above the axle; and
wherein the first link passes through the opening of the extension.

20. The apparatus of claim 19, wherein the first and second links comprise turnbuckles.
